(19) United States
(12) Patent Application Publication
(10) Pub. No.: US 2020/0082470 A1
(43) Pub. Date: Mar. 12, 2020

(54) COMBINED BLOCKCHAIN PLATFORM AND ASSOCIATED METHOD

(71) Applicant: Anuj Sharma, New Delhi (IN)

(72) Inventor: Anuj Sharma, New Delhi (IN)

(21) Appl. No.: 16/279,325

(22) Filed: Feb. 19, 2019

(30) Foreign Application Priority Data
Sep. 7, 2018 (IN) 201811033623

(51) Int. Cl. G06Q 40/02; H04L 9/06; H04L 9/32

(52) U.S. Cl. CPC G06Q 40/025; H04L 2209/38; H04L 9/3236; H04L 9/0637

(57) ABSTRACT

Described herein is a method and application platform system based on a block chain technology and created using blockchain technology and related software coding, programming languages, android technology, iOS technology, and/or azure cloud platform; the platform is incorporating multiple sub-platforms, such as BlockVOTE, BlockBOARD, BlockDRIVE, BlockAML, BlockLOAN, BlockPASSPORT and BlockVISA; and is supportive on any platforms/modes such as mobile phones, smart phones, tablets, computers, kiosks, digitals, screens, Virtual Reality supportive, Augmented Reality supportive and Mixed Reality; and incorporates block chain based encrypted digital verifications and transactions with Artificial Intelligence Instant Analytics. The platform can be accessible anytime, anywhere and by any user.

### CROSS-REFERENCE TO RELATED APPLICATION(S)

The present application claims priority to Indian Provisional Application 201811033623, entitled “The Blockworld Project,” filed Sep. 7, 2018 in English, the entire contents of which are hereby incorporated by reference in their entirety.

### FIELD OF INVENTION

The present invention relates generally to blockchain platforms and associated methods.

### BACKGROUND OF THE INVENTION

A short description of Blockchain: A blockchain is a growing list of records, called blocks, which are linked using cryptography. Each block contains a cryptographic hash of the previous block a timestamp, and transaction data (generally represented as a merkle tree root hash).

By design, a blockchain is resistant to modification of the data. It is “an open, distributed ledger that can record transactions between two parties efficiently and in a verifiable and permanent way”. For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. Although blockchain records are not unalterable, blockchains may be considered secure by design and exemplify a distributed computing system with high Byzantine fault tolerance. Decentralized consensus has therefore been claimed with a blockchain.

Blockchain was invented by Satoshi Nakamoto in 2008 to serve as the public transaction ledger of the cryptocurrency bitcoin. The invention of the blockchain for bitcoin made it the first digital currency to solve the double-spending problem without the need of a trusted authority or central server. The bitcoin design has inspired other applications, and blockchains which are readable by the public are widely used by cryptocurrencies. Private blockchains have been proposed for business use.

(Source: Wikipedia)

### SUMMARY OF INVENTION

Disclosed embodiments of the present invention use block chain technology for new areas of digital-paperless-encrypted public and private usage in digital election voting, intra-country visas, passports, ticketless travel-mobility, paperless loan disbursement, driving licenses and identity compliances. A platform (Blockworld) with multiple sub-platofrms can be provided, such as one or more of the following:
I. BlockVOTE: Blockchain based election voting platforms and software's with artificial intelligence based descriptive, predictive and prescriptive analytics
II. BlockBOARD: Blockchain based boarding passes for air, sea travel, tickets for rail and road, travel platforms and software's with artificial intelligence based descriptive, predictive and prescriptive analytics
III. BlockDRIVE: Blockchain based driving license, issuance, renewal platforms and software's with artificial intelligence based descriptive, predictive and prescriptive analytics
IV. BlockAML: Blockchain based KYC (Know your customer) verifications and AML platforms and software's with artificial intelligence based descriptive, predictive and prescriptive analytics
V. BlockLOAN: Blockchain based loan verification and disbursement platforms and software's with artificial intelligence based descriptive, predictive and prescriptive analytics
VI. BlockPASSPORT: Blockchain based passport verification, renewal and issuance platforms and software's with artificial intelligence based descriptive, predictive and prescriptive analytics
VII. BlockVISA: Blockchain based visa verification, renewal and issuance platforms and software's for embassies, immigrations and border control agencies with artificial intelligence based descriptive, predictive and prescriptive analytics

Technologies that can be used to create BlockWorld are:
i. Blockchain and related software coding, programming languages.
ii. Android
iii. iOS
iv. Azure Cloud Platform

BLOCKWORLD and its sub-platforms (or sub-applications) can be Mobility and computer-Mobile-Tablet-Smart Screen-Smart Glasses (Augmented Reality, Mixed Reality, Virtual Reality) supportive, incorporate Blockchain based encrypted digital verifications and transactions with Artificial Intelligence Instant Analytics. Blockworld is Accessible Anytime, Anywhere and by Any user.

The present summary is provided only by way of example, and not limitation. Other aspects of the present invention will be appreciated in view of the entirety of the present disclosure, including the entire text, claims and accompanying figures.

### BRIEF DESCRIPTION OF DRAWINGS

The foregoing detailed description of embodiments is better understood when read in conjunction with the appended drawing. For the purpose of illustrating the disclosure, there is shown in the present document example constructions of the disclosure; however, the disclosure is not limited to the specific methods disclosed in the document and the drawings.

The detailed description is described with reference to the accompanying figure. In the figure, the left-most digit(s) of a reference number identifies the figure in which the reference number first appears. The same numbers are used throughout the drawings to refer like features and components.

FIG. 1 to FIG. 21 provide a description of the capabilities and functionalities of Blockworld Platform and its applications and possible implementation on suitable hardware.

FIG. 1 shows the BlockWorld platform.

FIG. 2 depicts the Blockworld platform.

FIG. 3 depicts user selection of application.

FIG. 4 depicts User identification.

FIG. 5 is an exemplary embodiment depicting the type of elections

FIG. 6 shows the exemplary embodiment of multiple parameters of information for each candidate for user to make an informed decision.

FIG. 7 is an exemplary embodiment showing the expansion of Party details.

FIG. 8 is an exemplary embodiment showing the expansion of 6.3 i.e. Criminal Records screen.

FIG. 9 is an exemplary embodiment showing the expansion of 6.8 i.e. Manifesto and promises screen.

FIG. 10 is an exemplary embodiment showing the expansion of 6.5 i.e. carrier history screen.

FIG. 11 is an exemplary embodiment showing the expansion of 6.9 i.e. AI Analytics and Result screen.

FIG. 12 illustrates an embodiment of working of another application of BlockWorld called BlockPassport (2.3)

FIG. 13 depicts same as FIG. 4 in relation to BlockPassport

FIG. 14 depicts same as FIG. 5 in relation to BlockPassport

FIG. 15 screen comprises of screens for parameters from 15.1 TO 15.10 showing multiple DETAILS OF PASS PORT HOLDER (the user)

FIG. 16 depicts expansion of 6.9 screen as shown in FIG. 11 and in relation to BlockPassport

FIG. 17 illustrates an embodiment of working of another application of BlockWorld called BlockVisa (2.4)

FIG. 18 illustrates an embodiment of working of another application of BlockWorld called BlockBoard (2.2)

FIG. 19 shows the Architecture of BlockVisa (2.4)

FIG. 20 shows the Architecture of BlockDrive (2.7)

FIG. 21 is a schematic representation of a computer usable with embodiments of the present system.

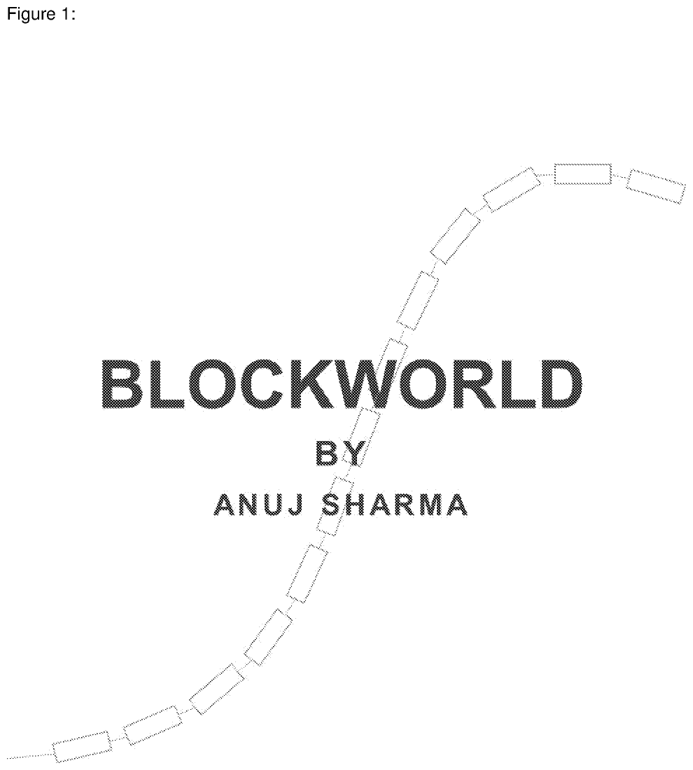

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. Although any methods similar or equivalent to those described herein can be used in the practice or testing of embodiments of the present disclosure, the exemplary, methods are now described.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

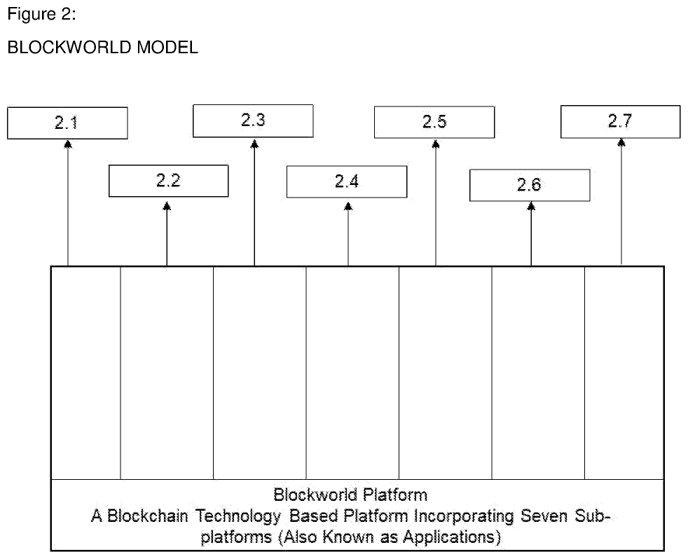

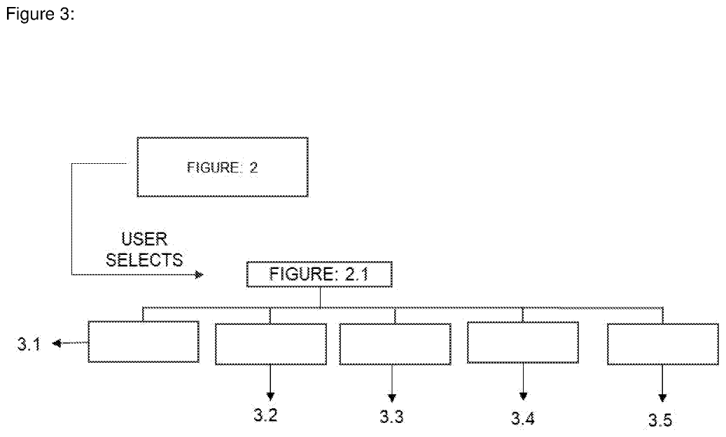

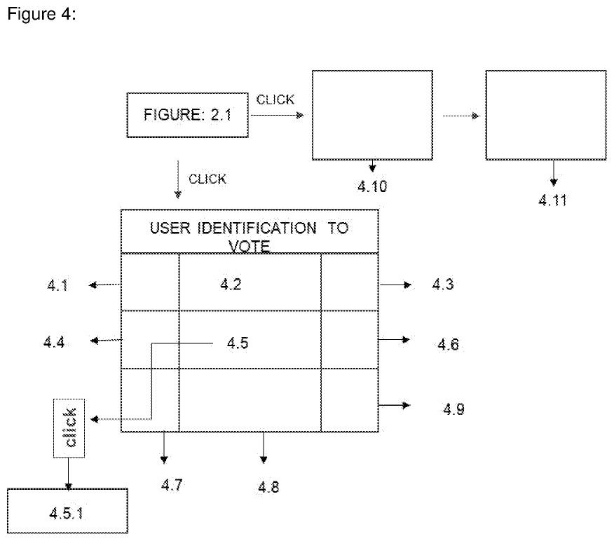

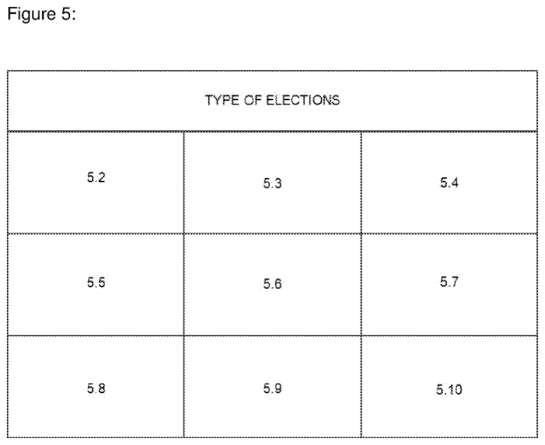

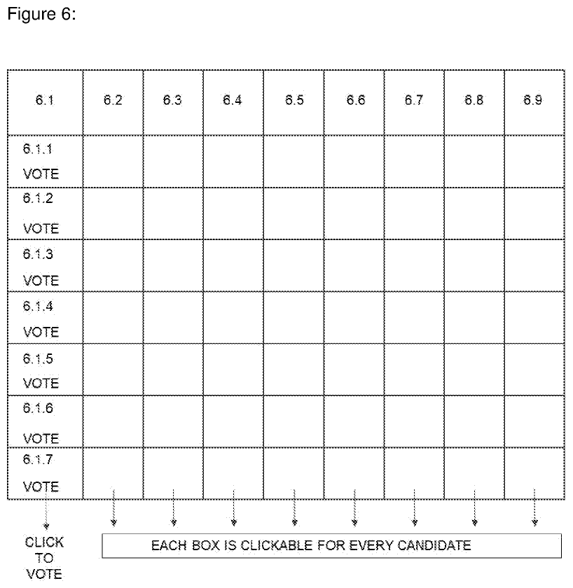

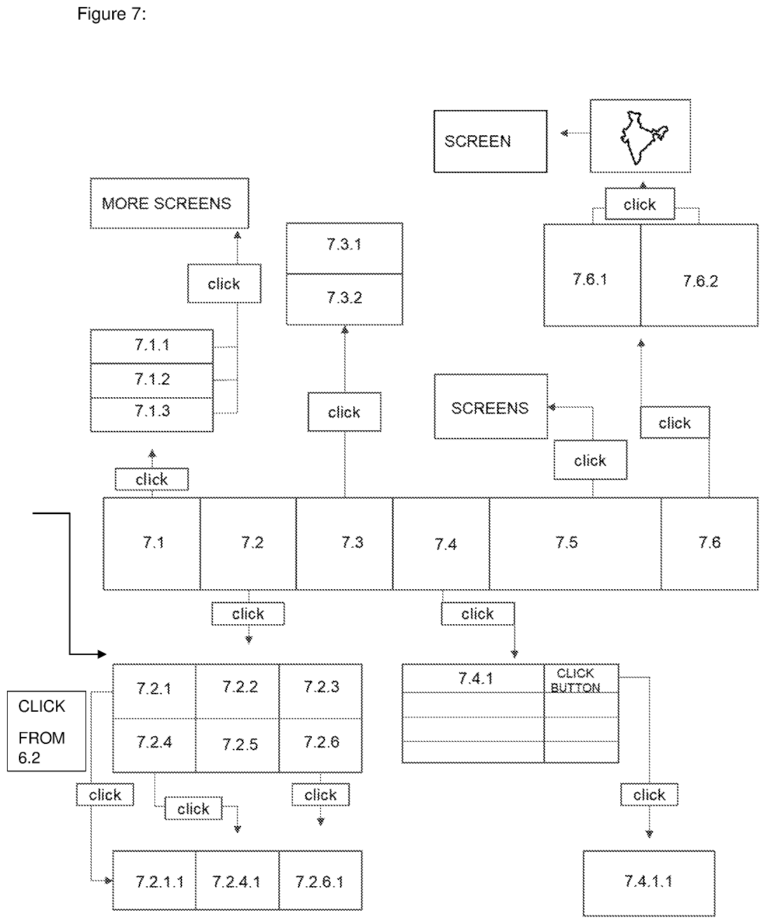

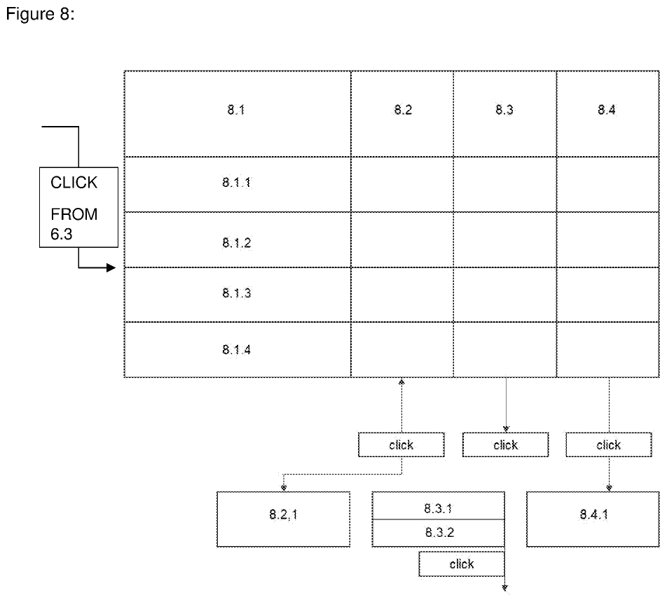

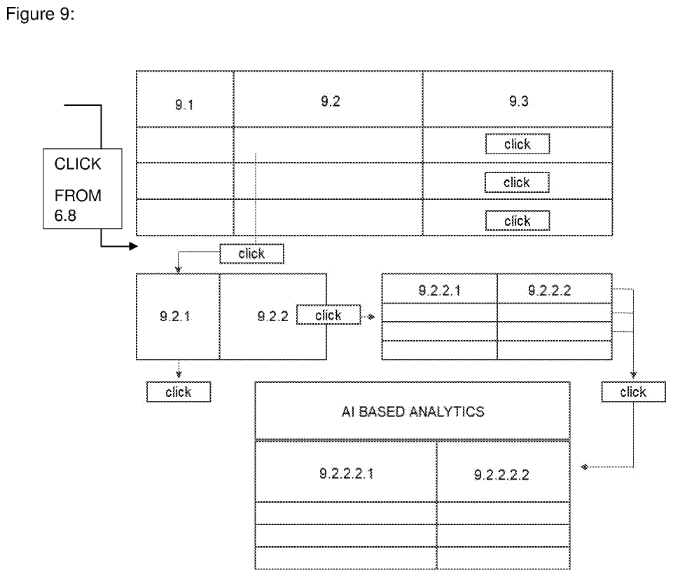

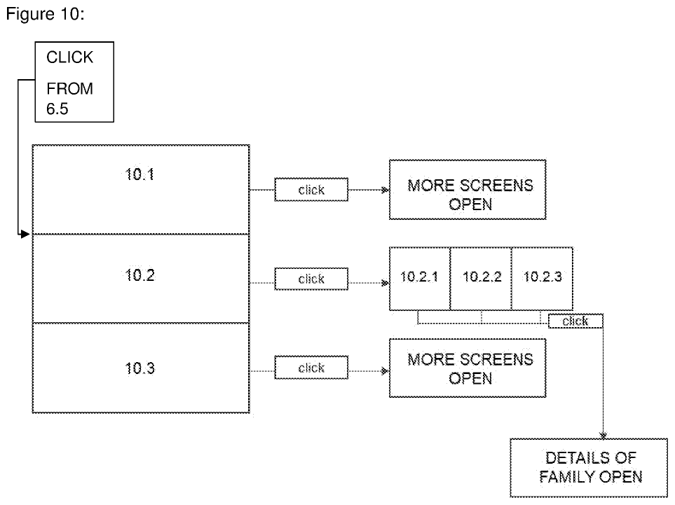

FIG. 2 depicts an embodiment of the Blockworld platform. It shows seven applications or sub-platforms that can be included in the blockworld platform: BlockVote (2.1), BlockBoard (2.2), BlockPassport (2.3), BlockVISA (2.4), BlockLoan (2.5), BlockAML (2.6), BlockDrive (2.7) User can Select any one of the seven applications as shown in FIG. 2. As an example, FIG. 3 depicts user selecting application: BlockVote (2.1). User can access Blockvote application on any available platforms/modes such as mobile phones, smartphone, tablets, computers, kiosk digital screens, Virtual reality, Augmented reality and Mixed reality as shown in FIG. 3 as Kiosk Screen (3.1), mobile phone screen (3.2), tablet screen (3.3), virtual reality (3.4), augmented and mixed reality (3.5)
The opening screen of BlockVote (2.1) application takes each user to blockchain based identification as shown in FIG. 4. The identification mechanism incorporates a range of identification technologies that can be used to create block of user identity on blockchain as shown in FIG. 4; AI enabled face recognition (4.1), AI enabled fingerprint (4.2), AI enabled voice recognition (4.3), AI enabled iris scan (4.4), AI enabled DNA matching (4.6), all other available identification modes can be configured in (4.7, 4.8, 4.9) buttons of FIG. 4. User selects the option of identification to proceed ahead. All Digital scans of all identification records of user are also available for viewing to the user (4.5) with an upload option of missing/new documents (4.5.1). The user who is not registered in Blockvote can also enroll using new Voter Registration option (4.10) which opens further screens for completing documentary details and registration (4.11). 4.11 takes to screen 4. AI refers to Artificial Intelligence
   Upon completing the blockchain identification in FIG. 4, user comes to options for selecting types of elections he is intending to vote for (FIG. 5). User can select the type of elections (5.1) he is participating in; National election (5.2), State-District Election (5.3), Municipal Election (5.4), Student Union Election (5.5), Worker Union Election (5.6), Company Board Election (5.7), User access to any other type of elections can be configured by selecting (5.8, 5.9, 5.10). Upon selecting from FIG. 5, user goes to FIG. 6.
   FIG. 6 shows the example of election candidates screen in BlockVote (2.1). Each electoral candidate's records are loaded into BlockVote (2.1) and also verified as a “block” on blockchain. FIG. 6 screen shows multiple parameters of information for each candidate for user to make an informed decision. The information parameters for each candidate are 6.1 CANDIDATE NAME, 6.2 PARTY DETAILS, 6.3 CRIMINAL RECORDS, 6.4 FINANCIAL RECORDS, 6.5 CAREER HISTORY, 6.6 AWARDS AND SOCIAL MEDIA FEEDS, 6.7 VIDEOS AND PHOTOS, 6.8 MANIFESTO AND PROMISES, 6.9 AI ANALYTICS AND RESULTS which upon clicking open into further screens. The user can click on the candidate for which the user will like to vote by clicking on Voting button (6.1.1 TO 6.1.7). Once the User votes, the vote is verified and encrypted as a block on blockchain and cannot be modified. More parameters can also be added as required.
An example of expanding 6.2 PARTY DETAILS screen is shown in FIG. 7. The information parameters for each Party are 7.1 HISTORY OF PARTY, 7.2 CONTACT PARTY, 7.3 PARTY FINANCIALS, 7.4 LAWS SUPPORTED BY PARTY, 7.5 OTHER CANDIDATES OF PARTY, 7.6 PARTY ELECTION ANALYTICS which upon clicking open into further screens. The parameter of 7.1 HISTORY OF PARTY opens into 7.1.1 DIGITAL RECORDS, 7.1.2 PHOTOS, 7.1.3 VIDEOS. The parameter of 7.2 CONTACT PARTY opens into 7.2.1 SKYPE which opens further into 7.2.1.1 SKYPE HOMEPAGE, 7.2.2 MUTE, 7.2.3 WHATSAPP, 7.2.4 PHONE which opens further into 7.2.4.1 DIALPAD, 7.2.5 GOOGLE SEARCH, 7.2.6 EMAIL TO PARTY which opens further into 7.2.6.1 VOTER EMAIL OPENS. The parameter of 7.3 PARTY FINANCIALS further opens into 7.3.1 DIGITAL SCANS and 7.3.2 ANALYTICS. The parameter of 7.4 LAWS SUPPORTED BY PARTY further opens into 7.4.1 LAW DETAILS which further opens to 7.4.1.1 DIGITAL SCANS OF LAWS. The parameter of 7.5 OTHER CANDIDATES OF PARTY opens into further screens. The Parameter of 7.6 PARTY ELECTION ANALYTICS opens into 7.6.1 ANALYTICS—ELECTION RESULTS (any part of any country can be selected here) and 7.6.2 ANALYTICS—ELECTION SURVEY (any part of any country can be selected here) which open to further screens. More parameters can also be added as required.
An example of expanding 6.3 CRIMINAL RECORDS screen is shown in FIG. 8. The information parameters for 6.3 are 8.1 TYPES OF CRIMINAL RECORD which opens further into 8.1.1 TYPES OF CRIMINAL RECORD 1, 8.1.2 TYPES OF CRIMINAL RECORD 2, 8.1.3 TYPES OF CRIMINAL RECORD 3, 8.1.4 TYPES OF CRIMINAL RECORD 4. The parameter of 8.2 DIGITAL RECORDS which further opens into 8.2.1 DIGITAL SCAN SCREENS. The parameter of 8.3 VIDEOS AND RECORDS which further opens into 8.3.1 VIDEOS and 8.3.2 PHOTOS. The parameter of 8.4 CONVICTION DETAIL RECORDS which further opens into 8.4.1 DIGITAL SCANS OPEN. More parameters can also be added as required.
An example of expanding 6.8 MANIFESTO AND PROMISES screen is shown in FIG. 9. The information parameters for 6.8 are 9.1 BY YEAR, 9.2 PARTY MANIFESTO which further opens into screens of 9.2.1 DIGITAL SCANS, 9.2.2 AI BASED ANALYTICS which opens into screens of 9.2.2.1 MANIFESTO PROMISE and 9.2.2.2 ANALYTICS. The parameter of 9.2.2.2 ANALYTICS further opens into 9.2.2.2.1 DETAILS and 9.2.2.2.2 GRAPHS/CHARTS/VISUALISATION/PERCENTAGE COMPLETION. Another parameter for 6.8 is 9.3 CANDIDATE PROMISE. More parameters can also be added as required.
An example of expanding 6.5 CAREER HISTORY screen is shown in FIG. 10. The information parameters for 6.5 are 10.1 CANDIDATE CAREER HISTORY and 10.2 CANDIDATE FAMILY DETAILS which opens into screens of 10.2.1 SPOUSE DETAILS 10.2.2 CHILD 1 DETAILS 10.2.3 CHILD 2 DETAILS. Another parameter for 6.5 is 10.3 CANDIDATE BUSINESS DETAILS. More parameters can also be added as required.

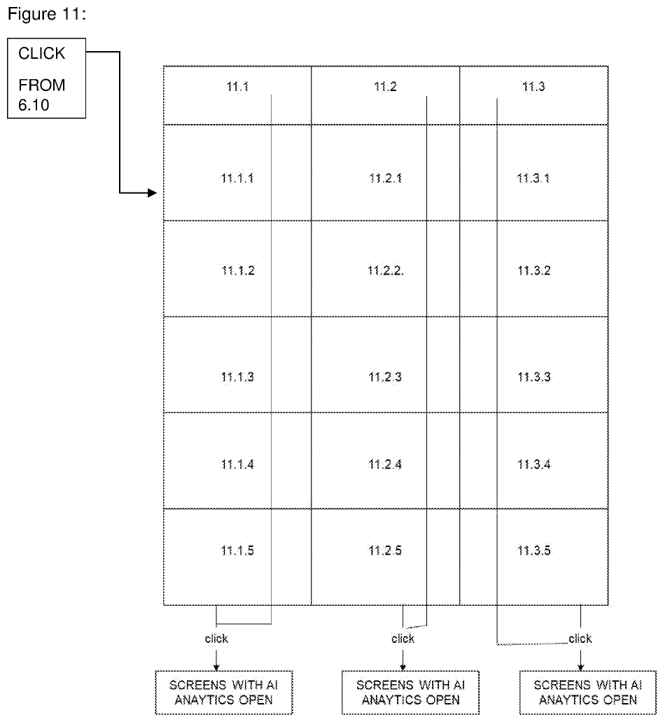

An example of expanding 6.9 AI ANALYTICS AND RESULTS screen is shown in FIG. 11. The information parameters for 6.9 are 11.1 DESCRIPTIVE ANALYTICS+RESULTS which further opens into 11.1.1 FOR ALL POLITICAL PARTIES, 11.1.2 FOR ALL CANDIDATES, 11.1.3 FOR EVERY STATE/DISTRICT AND CONSTITUENCY, 11.1.4 FOR ALL TYPE OF ELECTIONS, 11.1.5 FOR EVERY COUNTRY GLOBALLY. More parameters can also be added as required for descriptive analytics.

When user selects 11.2 PREDICTIVE ANALYTICS+RESULTS, it opens further screens; 11.2.1 FOR ALL POLITICAL PARTIES, 11.2.2 FOR ALL CANDIDATES, 11.2.3 FOR EVERY STATE/DISTRICT AND CONSTITUENCY, 11.2.4 FOR ALL TYPE OF ELECTIONS, 11.2.5 FOR EVERY COUNTRY GLOBALLY. More parameters can also be added as required for predictive analytics. When user selects 11.3 PRESCRIPTIVE ANALYTICS+RESULTS it opens further screens; 11.3.1 FOR ALL POLITICAL PARTIES, 11.3.2 FOR ALL CANDIDATES, 11.3.3 FOR EVERY STATE/DISTRICT AND CONSTITUENCY, 11.3.4 FOR ALL TYPE OF ELECTIONS, 11.3.5 FOR EVERY COUNTRY GLOBALLY. More parameters can also be added as required for prescriptive analytics. AI refers to Artificial Intelligence. All analytics in this screen are AI enabled. Graphs, Infographics, Charts, etc. can be used in these analytics also.

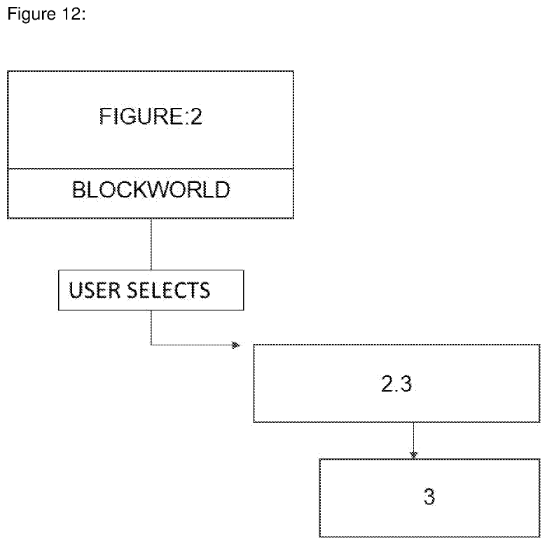

FIG. 12 illustrates the example of working of another application of BlockWorld called BlockPassport (2.3). In FIG. 12, 2. REFERS TO FIG. 2 IN THE PATENT DOCUMENT. [FIG. 2 depicts the Blockworld platform in its totality. It shows the seven applications of blockworld platform namely; BlockVote (2.1), BlockBoard (2.2), BlockPassport (2.3), BlockVISA (2.4), BlockLoan (2.5), BlockAML (2.6), BlockDrive (2.7). user selects application: BlockPassport (2.3). User can access Blockvote application on any available platforms/modes such as mobile phones, smartphone, tablets, computers, kiosk digital screens, Virtual reality, Augmented reality and Mixed reality as shown in 3.1, 3.2, 3.3, 3.4, 3.5 of FIG. 3

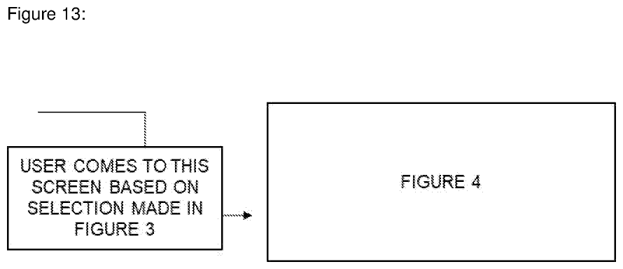

FIG. 13 depicts same as FIG. 4. The opening screen of BlockPassport (2.3) application takes each user to blockchain based identification as shown in FIG. 4. The identification mechanism incorporates a range of identification technologies that can be used to create block of user identity on blockchain as shown in FIG. 4; AI enabled face recognition (4.1), AI enabled fingerprint (4.2), AI enabled voice recognition (4.3), AI enabled iris scan (4.4), AI enabled DNA matching (4.6), all other available identification modes can be configured in (4.7, 4.8, 4.9) buttons of FIG. 4. User selects the option of identification to proceed ahead. All Digital scans of all identification records of user are also available for viewing to the user (4.5) with an upload option of missing/new documents (4.5.1). The user who is not registered in BlockPassport (2.3) can also enroll using new Voter Registration option (4.10) which opens further screens for completing documentary details and registration (4.11). AI refers to Artificial Intelligence

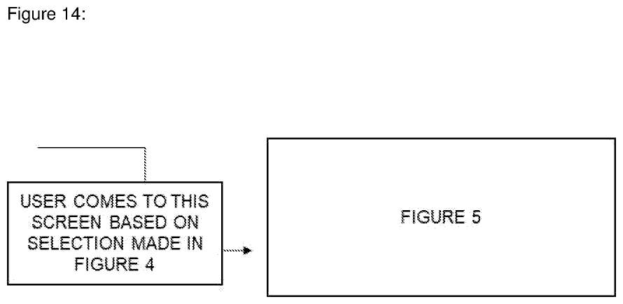

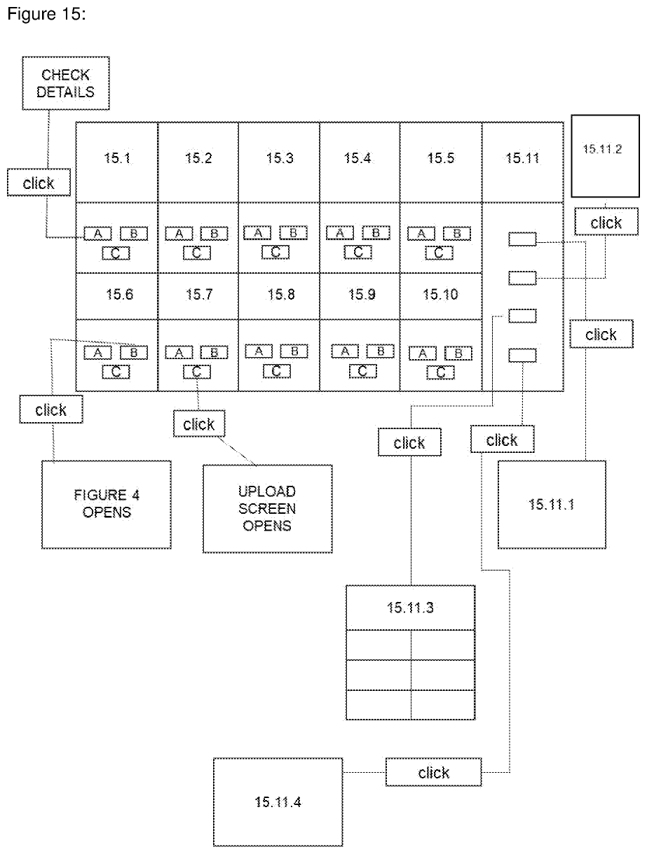

FIG. 14 depicts same as FIG. 5. Upon completing the blockchain identification in FIG. 4, user comes to options for selecting types of passport he/she is intending to obtain using BlockPassport (2.3). All Types of Passport will be available for the user to select as per regulations of the user's country. upon selecting from FIG. 5, user goes to FIG. 15 of BlockPassport (2.3)

FIG. 15 screen comprises of screens for parameters from 15.1 TO 15.10 showing multiple DETAILS OF PASS PORT HOLDER (the user). More parameters can also be added as required. Under each parameter from 15.1 to 15.10, user has 3 options to select for each parameter: A-CHECK DETAILS, B-SUBMIT BUTTON and C-UPLOAD BUTTON which opens further screens. Selecting B-SUBMIT BUTTON or C-UPLOAD BUTTON takes user to FIG. 4 (blockchain identification). FIG. 15 also has parameter of 15.11 DETAILS OF PREVIOUS PASS PORT which has options of 15.11.1 Digital scans of previous passports, 15.11.2 User History (modelled as FIG. 10), 15.11.3 PASSPORT HISTORY which opens into further screens and 15.11.4 CRIMINAL RECORDS (modelled as FIG. 8)

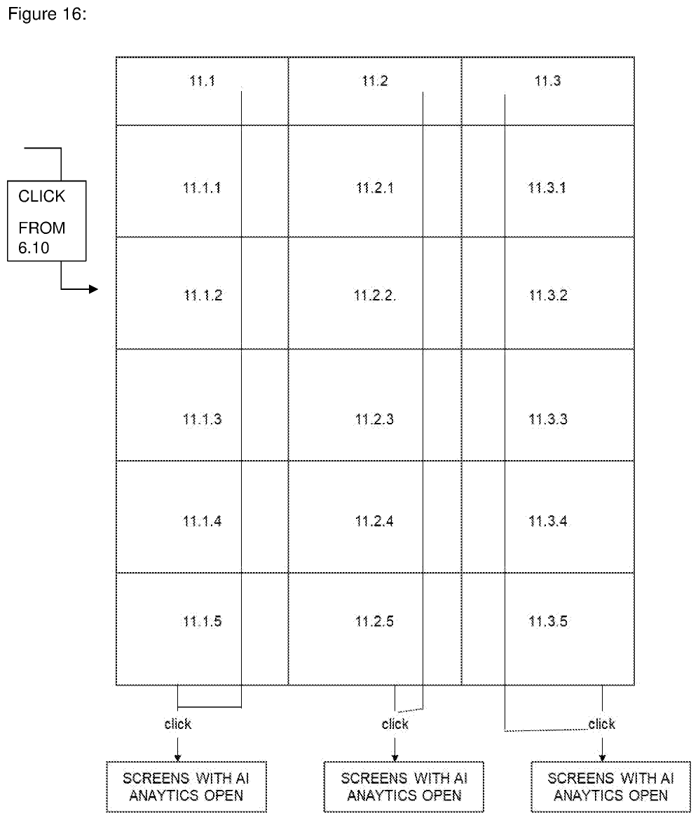

FIG. 16 will be expanding 6.9 AI ANALYTICS AND RESULTS screen is shown in FIG. 11 but modelled on parameters of BlockPassport (2.3) as required by issuing passport authorities. The information parameters will be 16.1 DESCRIPTIVE ANALYTICS+RESULTS which further opens into screens. More parameters can also be added as required for descriptive analytics. When user selects 16.2 PREDICTIVE ANALYTICS+RESULTS, it opens further screens. More parameters can also be added as required for predictive analytics. When user selects 16.3 PRESCRIPTIVE ANALYTICS+RESULTS it opens further screens. More parameters can also be added as required for prescriptive analytics. AI refers to Artificial Intelligence. All analytics in this screen are Alenabled. Graphs, Infographics, Charts, etc. can be used in these analytics also.

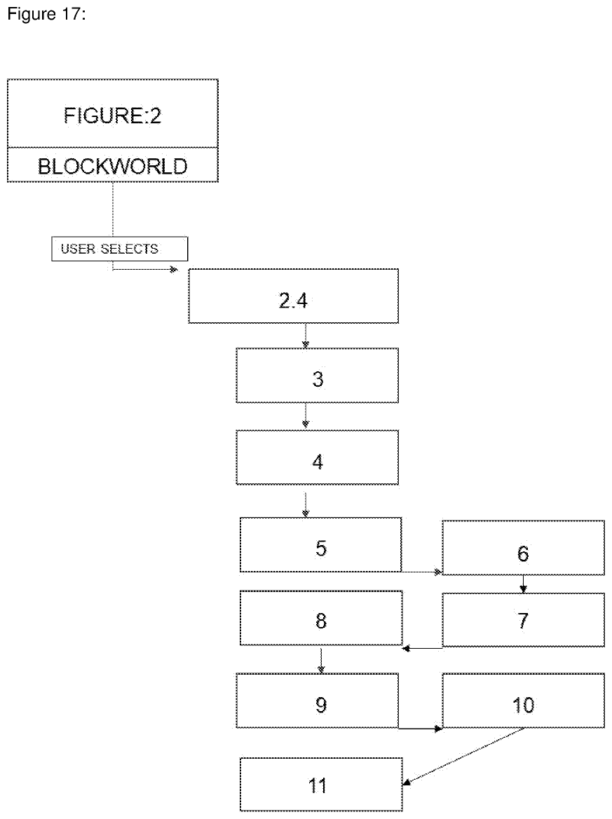

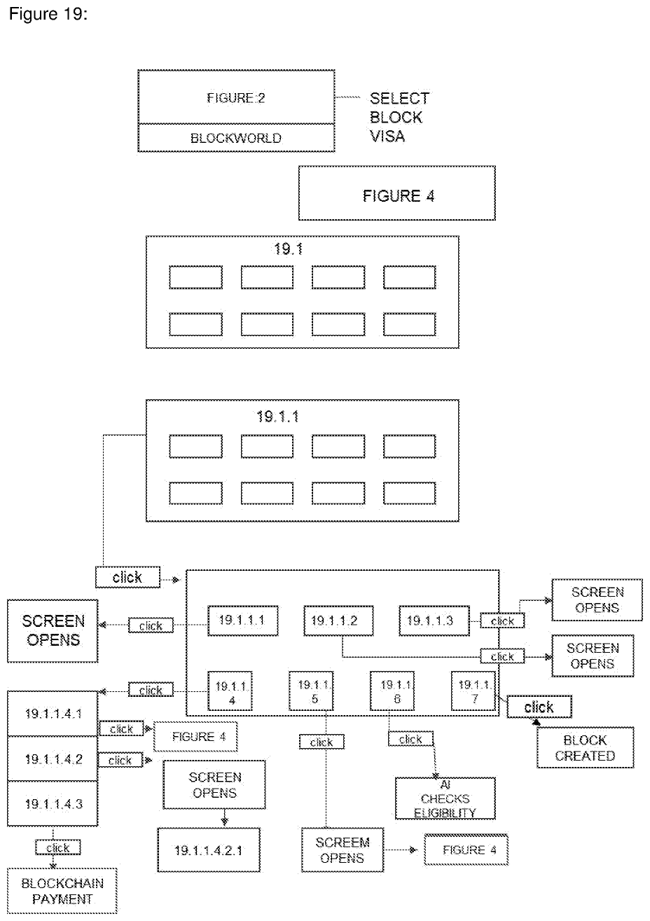

FIG. 17 is example of BlockVISA (2.4) Application in BlockWorld. BlockVISA (2.4) will be modelled same as FIG. 2, FIG. 3, FIG. 4, FIG. 5, FIG. 6, FIG. 7, FIG. 8, FIG. 9, FIG. 10 and FIG. 11, however the parameters will change as per visa issuing, renewal and verification requirements of each country and its embassy, immigration and border control regulations in these figures. BlockVISA (2.4) architecture is depicted in FIG. 19.

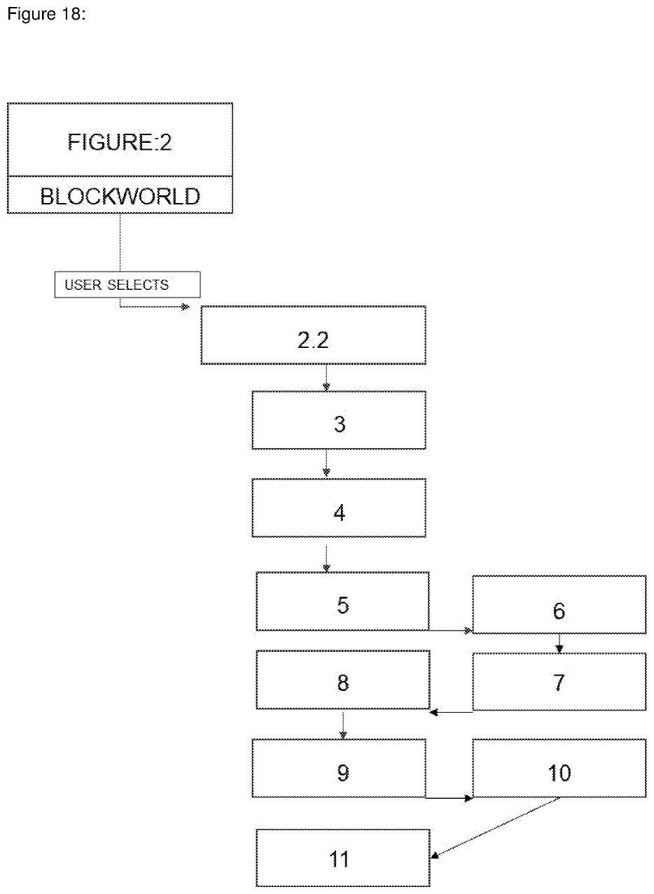

FIG. 18 is example of BlockBoard (2.2) Application in BlockWorld. BlockBoard (2.2) will be modelled same as FIG. 2, FIG. 3, FIG. 4, FIG. 5, FIG. 6, FIG. 7, FIG. 8, FIG. 9, FIG. 10 and FIG. 11, however the parameters will change as per Airline Ticketing-Boarding passes, Rail Tickets including Coach-cabin access, Ship tickets including coach and cabin access and Bus tickets-based requirements of each transport-mobility provider and country regulations in these figures. BlockBoard (2.2) will ensure passenger authentication at various points of entry-exit in mobility systems using FIG. 4.

FIG. 19 shows the architecture of BlockVISA (2.4). User selects application: BlockVISA (2.4). User can access BlockVisa (2.4) application on any available platforms/modes such as mobile phones, smartphone, tablets, computers, kiosk digital screens, Virtual reality, Augmented reality and Mixed reality as shown in 3.1, 3.2, 3.3, 3.4, 3.5 as shown in FIG. 3

The opening screen of BlockVisa (2.4) application takes each user to blockchain based identification as shown in FIG. 4. The identification mechanism incorporates a range of identification technologies that can be used to create block of user identity on blockchain as shown in FIG. 4; AI enabled face recognition (4.1), AI enabled fingerprint (4.2), AI enabled voice recognition (4.3), AI enabled iris scan (4.4), AI enabled DNA matching (4.6), all other available identification modes can be configured in (4.7, 4.8, 4.9) buttons of FIG. 4. User selects the option of identification to proceed ahead. All Digital scans of all identification records of user are also available for viewing to the user (4.5) with an upload option of missing/new documents (4.5.1). The user who is not registered in BlockVisa (2.4) can also enroll using new Registration option (4.10) which opens further screens for completing documentary details and registration (4.11). AI refers to Artificial Intelligence. Upon completing the blockchain identification in FIG. 4, user comes to options for selecting the country or countries he/she is intending to visit as shown in 19.1 COUNTRY OF VISIT. User can select multiple countries to visit also. Selecting the country takes user to 19.1.1 TYPE OF VISAS COUNTRY WISE where all types of visas of that country are listed for user to select. Upon selecting the type of visa, screen open for that selected visas which includes (but not limited to) 19.1.1.1 VISA GUIDELINES, 19.1.1.2 VISA ELIGIBILITY, 19.1.1.3 PAST VISA ISSUED and 19.1.1.4 VISA APPLICATION. Upon selecting 19.1.1.4 VISA APPLICATION, further screens open such as 19.1.1.4.1 IDENTIFICATION, 19.1.1.4.2 OTHER FIELD, 19.1.1.4.3 PAY FEES. Selecting 19.1.1.4.3 PAY FEES takes user to blockchain based payment system screens. Selecting 19.1.1.4.2 OTHER FIELD opens screens of 19.1.1.4.2.1 USER VISA INTERVIEW which can be done in Augmented Reality, Mixed Reality, Virtual Reality or Video mode also apart from scheduling face to face interview. AI enabled cameras will be able to conduct face detection of candidate's answers and emotions including facial expressions related to lying and untruthfulness of visa questions. Other paraments available for selection are 19.1.1.5 FAMILY MEMBER, 19.1.1.6 VISA RENEWAL which opens to further screens. User has option of submitting his application using parameter 19.1.1.7 SUBMIT which creates the “block” of the completed application and send to visa issuing authority. Parameters and screens can be modified as per requirement.

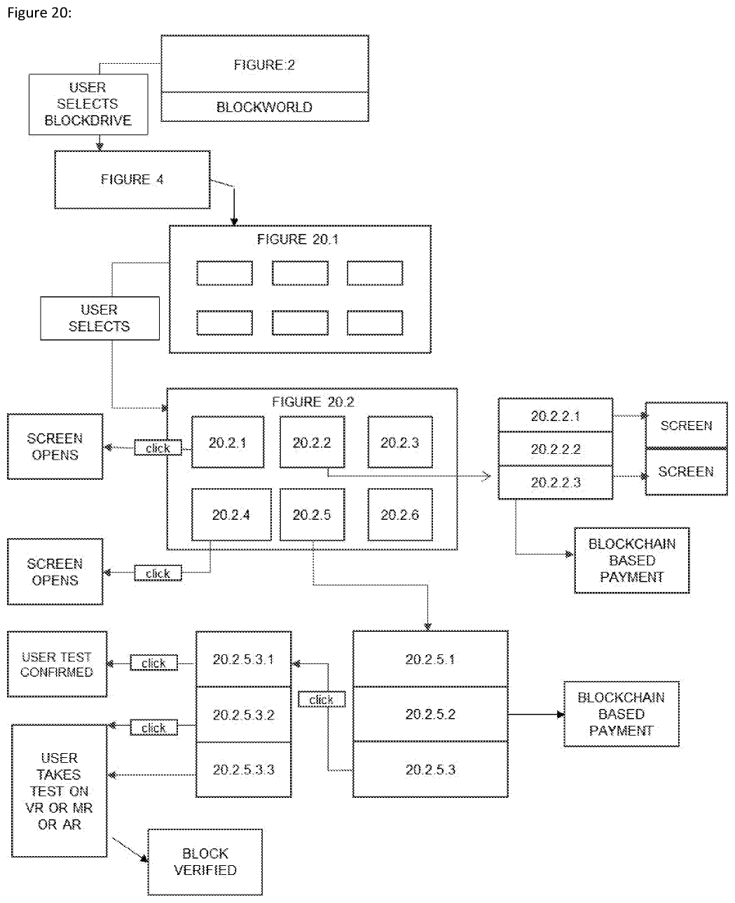

FIG. 20 shows the architecture of BlockDrive (2.7). User selects application: BlockDrive (2.7). User can access BlockDrive (2.7) application on any available platforms/modes such as mobile phones, smartphone, tablets, computers, kiosk digital screens, Virtual reality, Augmented reality and Mixed reality as shown in 3.1, 3.2, 3.3, 3.4, 3.5 as shown in FIG. 3

As shown in FIG. 20: The opening screen of BlockDrive (2.7) application takes each user to blockchain based identification as shown in FIG. 4. The identification mechanism incorporates a range of identification technologies that can be used to create block of user identity on blockchain as shown in FIG. 4; AI enabled face recognition (4.1), AI enabled fingerprint (4.2), AI enabled voice recognition (4.3), AI enabled iris scan (4.4), Alenabled DNA matching (4.6), all other available identification modes can be configured in (4.7, 4.8, 4.9) buttons of FIG. 4. User selects the option of identification to proceed ahead. All Digital scans of all identification records of user are also available for viewing to the user (4.5) with an upload option of missing/new documents (4.5.1). The user who is not registered in BlockDrive (2.7) can also enroll using new Registration option (4.10) which opens further screens for completing documentary details and registration (4.11). AI refers to Artificial Intelligence. Upon completing the blockchain identification in FIG. 4, user comes to options for selecting the types of licenses he/she is intending to obtain as shown in 20.1 TYPES OF DRIVING LICENSES (Car, Drone, Bike, Truck, Motorcycle, Rail, Ship, Airplane, helicopter etc.). Upon selecting, screens open for 20.2 OPTIONS which comprise of 0.20.2.1 LICENSE HISTORY OF USER, 20.2.2 FINES which further opens into screens of 20.2.2.1 HISTORICAL FINES, 20.2.2.2 OUTSTANDING FINES, 20.2.2.3 PAY FINES. 20.2 OPTIONS also have other parameters such as 20.2.3 TRAFFIC VIOLATIONS 20.2.4 LICENSE GUIDELINES which open into further screens. Parameters and screens can also be modified as per requirement. 20.2 OPTIONS also have other parameters such as 20.2.5 LICENSE APPLICATION which opens into other screens such as 20.2.5.1 DETAILS, 20.2.5.2 PAY FEES, 20.2.5.3 DRIVING TEST. 20.2.5.2 PAY FEES take user to blockchain based payment system screens. 20.2.5.3 DRIVING TEST opens to further screens of 20.2.5.3.1 IN PERSON, 20.2.5.3.2 VIRTUAL REALITY, 20.2.5.3.3 AUGMENTED REALITY. License tests can be done in Augmented Reality, Mixed Reality, Virtual Reality or Video mode also apart from scheduling face to face interview. AI enabled cameras will be able to conduct face detection of candidate's answers and emotions including facial expressions related to licenses. 20.2 OPTIONS also have parameters of 20.2.6 LICENSE RENEWAL which opens into further screens.

In (2.4), BlockLoan (2.5) and BlockAML (2.6) Application in BlockWorld. Both (2.4), BlockLoan (2.5) and BlockAML (2.6) will be modelled same as FIG. 2, FIG. 3, FIG. 4, FIG. 5, FIG. 6, FIG. 7, FIG. 8, FIG. 9, FIG. 10 and FIG. 11, however the parameters will change as per requirements and regulations in these figures. Both (2.4), BlockLoan (2.5), BlockAML (2.6) will ensure authentication at various points using FIG. 4. In case of BlockLoan (2.5), the loan disbursement and all its installments will also be created as a “block” on blockchain. BlockAML (2.6) creates the KYC (Know your Customer) and (Anti Money laundering) “Blocks” of each user in the Blockchain which can be accessed by any authority for verifications and subsequent processing.

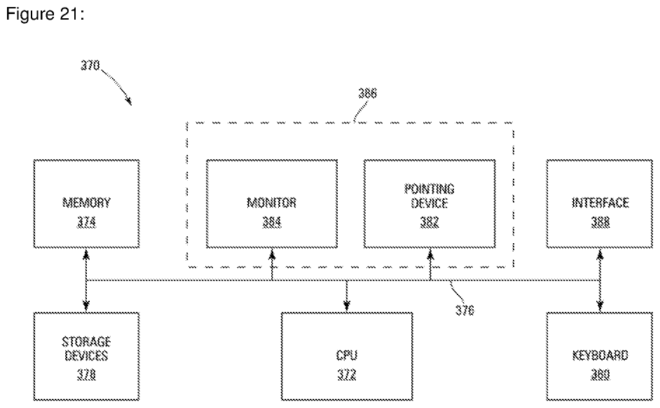

FIG. 21 and the related discussion provide a brief, general description of a suitable computing environment in which embodiments of the present disclosure can be implemented. Although not required, components of the system can be implemented at least in part, in the general context of computer-executable instructions, such as program modules, being executed by a computer 370 which may be connected in wired or wireless fashion to smart eyewear (e.g., VR glasses and/or projectors). Generally, program modules include routine programs, objects, components, data structures, etc., which perform particular tasks or implement particular abstract data types. Those skilled in the art can implement the description herein as computer-executable instructions storable on a computer readable medium. Moreover, those skilled in the art will appreciate that the invention may be practiced with other computer system configurations, including multi-processor systems, networked personal computers, mini computers, main frame computers, smart screens, mobile devices (e.g., smart phones, tablets) and the like. Aspects of the invention may also be practiced in distributed computing environments where tasks are performed by remote processing devices that are linked through a communications network. In a distributed computer environment, program modules may be located in both local and remote memory storage devices.

The computer 370 comprises a conventional computer having a central processing unit (CPU) 372, memory 374 and a system bus 376, which couples various system components, including memory 374 to the CPU 372. The system bus 376 may be any of several types of bus structures including a memory bus or a memory controller, a peripheral bus, and a local bus using any of a variety of bus architectures. The memory 374 includes read only memory (ROM) and random access memory (RAM). A basic input/output (BIOS) containing the basic routine that helps to transfer information between elements within the computer 370, such as during start-up, is stored in ROM. Storage devices 378, such as a hard disk, a floppy disk drive, an optical disk drive, etc., are coupled to the system bus 376 and are used for storage of programs and data. It should be appreciated by those skilled in the art that other types of computer readable media that are accessible by a computer, such as magnetic cassettes, flash memory cards, digital video disks, random access memories, read only memories, and the like, may also be used as storage devices. Commonly, programs are loaded into memory 374 from at least one of the storage devices 378 with or without accompanying data.

Input devices such as a keyboard 380 and/or pointing device (e.g. mouse, joystick(s)) 382, or the like, allow the user to provide commands to the computer 370. A monitor 384 or other type of output device can be further connected to the system bus 376 via a suitable interface and can provide feedback to the user. If the monitor 384 is a touch screen, the pointing device 382 can be incorporated therewith. The monitor 384 and input pointing device 382 such as mouse together with corresponding software drivers can form a graphical user interface (GUI) 386 for computer 370. Interfaces 388 on the system controller 300 allow communication to other computer systems if necessary. Interfaces 388 also represent circuitry used to send signals to or receive signals from the actuators and/or sensing devices mentioned above. Commonly, such circuitry comprises digital-to-analog (D/A) and analog-to-digital (A/D) converters as is well known in the art.

Although the present invention has been described with reference to preferred embodiments, workers skilled in the art will recognize that changes may be made in form and detail without departing from the spirit and scope of the invention.

What is claimed is:

1. A blockchain application platform system comprising:
a plurality of sub-platforms executable via a computing device having at least one processor, the plurality of sub-platforms including a blockchain-based election voting sub-platform, a blockchain-based boarding pass sub-platform, a blockchain-based driver's license sub-platform, a blockchain-based know-your-customer (KYC) verification and anti-money laundering (AML) sub-platform, a blockchain-based loan verification and disbursement sub-platform, a blockchain-base passport verification, renewal and issuance sub-platform, and a blockchain-based visa and immigration sub-platform, wherein each of the plurality of sub-platforms incorporates block chain based encrypted digital verifications and transactions with artificial intelligence (AI) instant analytics.

2. A blockchain application platform system as claimed in claim 1 comprising machine-readable instructions executable by the computing device to generate a user interface with a blockchain-based identification mechanism to create a user identity block on block chain, the identification mechanism selected from the group consisting of AI-enabled face recognition, AI-enabled fingerprint recognition, AI-enabled voice recognition, AI-enabled iris scan, AI-enabled DNA matching, and combinations thereof.

3. A blockchain application platform system as claimed in claim 1 comprising machine-readable instructions executable by the computing device to generate a user interface presenting a user with an option to select anyone of the seven sub-platforms.

4. A method of using the blockchain application platform, the method comprising:
selecting a system application using a computing device;
completing a blockchain-based artificial intelligence (AI) enabled identification;
after completing the block-chain AI enabled identification, selecting one of a plurality of sub-platforms; and
if a blockchain-based election voting sub-platform is selected, then performing the steps of:
selecting a type of election;
after selecting the type of election, displaying election candidate records, wherein each electoral
candidate record is verified as a block on block chain; and
after displaying the election candidate records, submitting a vote that creates a completed application block.

5. The method as claimed in claim 4, wherein if a blockchain-based boarding pass sub-platform is selected, then performing the step of:
creating a block for passenger authentication at one or more entry/exit points in a mobility system.

6. The method as claimed in claim 4 wherein if a blockchain-based driver's license sub-platform is selected, then performing the steps of:
displaying digital scans of identification records;
presenting a user interface to upload documents; and
presenting another user interface for new user registration.

7. The method as claimed in claim 4 wherein if a blockchain-based know-your-customer (KYC) verification and anti-money laundering (AML) sub-platform is selected, then performing the step of:
creating KYC and AML blocks of each user in a block chain, wherein the KYC and AML blocks are accessible for external verifications and subsequent processing.

8. The method as claimed in claim 4 wherein if a blockchain-based loan verification and disbursement sub-platform is selected, then performing the step of:
creating a block of loan disbursements and corresponding loan installments on blockchain of each user in the block chain.

9. The method as claimed in claim 4 wherein if a blockchain-based passport sub-platform is selected, then performing the steps of:
displaying digital scans of identification records;
presenting a user interface to upload documents; and
presenting another user interface for new user registration.

10. The method as claimed in claim 4 wherein if a blockchain-based passport sub-platform is selected, then performing the steps of:
creating a block compliant with embassy, immigration and boarder control regulations.
